(19) United States
(12) Patent Application Publication
(10) Pub. No.: US 2016/0371454 A1
(43) Pub. Date: Dec. 22, 2016

(54) LIFESTYLE ANALYSIS SYSTEM AND METHOD

(71) Applicant: AJOU UNIVERSITY INDUSTRY-ACADEMIC COOPERATION FOUNDATION, Suwon-si Gyeonggi-do (KR)

(72) Inventor: We Duke CHO, Seongnam-si (KR)

(73) Assignee: AJOU UNIVERSITY INDUSTRY-ACADEMIC COOPERATIO FOUNDATION, Suwon-si, Gyenggi-do (KR)

(21) Appl. No.: 14/901,561

(22) PCT Filed: Jun. 25, 2014
(86) PCT No.: PCT/KR2014/005621

§ 371 Date: Dec. 28, 2015

(30) Foreign Application Priority Data
Jun. 25, 2013 (KR) 10-2013-0072846

(51) Int. Cl. G06F 19/00; G06Q 50/00; G06Q 50/22

(52) U.S. Cl. CPC G06F 19/3437; G06Q 50/22; G06Q 50/01

(57) ABSTRACT

The present invention relates to a technique of managing a lifestyle, and more particularly, to a technique of analyzing a use's tendency by collecting big data of an personal lifestyle, storing a reference model generated by using the big data, and comparing lifelog data collected from the user based on the stored reference model to extract similarity and difference.

One aspect of the present invention provides a system for analyzing a lifestyle including a log collecting unit, a reference model storing unit, a pattern extracting unit, a tendency analyzing unit, and a personalized model generating unit.

### TECHNICAL FIELD

The present invention relates to a technique of managing a lifestyle, and more particularly, to a technique of analyzing a user's tendency by collecting big data of a personal lifestyle, storing a reference model generated by using the big data, and comparing lifelog data collected from the user based on the stored reference model to extract similarity and difference.

### BACKGROUND ART

In Korea, particularly, patients with lifestyle-related diseases are rapidly increased, and patients with similar metabolic diseases which are not simply explained only westernization of dietary life, aging, and an increase in obese people appears from infancy and adolescence. The lifestyle-related diseases are not resolved well by medical drug treatment and medical costs of national health insurance have steadily increased with development of chronic diseases. As the solution thereof, lifestyle medicine has been important, but is difficult to be applied due to problems such as difficulty of a traditional medial examination method, continuous treatment effect, systematic management of the patients, and substantial effects.

Currently, various IT products and care services (child protection and growth care, elderly protection care, spiritual healing care of the public, financial forecasting management in a rapidly changing economic situation, and the like) have fundamental limits in application and advancement because understanding, expression, and quantifying for “human” as the final user and a complicated characteristic thereof (social relationship, psychology, physiology, emotion, and the like) are not easy.

Particularly, consideration for elements that determine “I” represented by the lifestyle is insufficient, and there is difficulty in tools or methods to characteristically express the human beings with complicated and various characteristics.

As a method for overcoming the problems, various researches of using lifelog data have been conducted globally, but absence of innovative devices for collecting the lifelog and dilemma of semantic analysis of a vast amount of data are still not resolved.

As an example of a life care service technique in the related art, “a system of providing a life care service” in Korea Patent Publication No. 2012-0045459 was proposed. In the prior art, a life care service technique of collecting information as a life required to verify a health state of the user and analyzing lifelog information to provide life care information used for managing the lifestyle of the user was disclosed.

However, in the related art, in order to manage the lifestyle of the user by analyzing the lifelog information, first, a process of setting the lifestyle is required and rules corresponding to a specific situation need to be predetermined. In the prior art, the predetermined rules have individual differences, but are not considered and not properly changed depending on the time flow, and a detailed technique for a method of setting the rules is not mentioned. Further, in the prior art, when the lifelog is analyzed, human diversity is not considered.

Therefore, a method of managing a user's health by collecting big data of a personal lifelog, performing a semantic analysis using the big data to extract a general behavior sequence and a behavior sequence according to a personalized lifestyle, and modeling the extracted behavior sequence to infer a behavior to occur according to a user's state and induce the inferred behavior in a desirable direction is required.

### DISCLOSURE

### Technical Problem

The present invention is directed to provide a system and a method for analyzing a lifestyle.

In detail, the present invention is directed to provide a system and a method for analyzing a lifestyle which analyze a user's tendency by collecting big data of a personal lifestyle, storing a reference model generated by using the big data, and comparing lifelog data collected from the user based on the stored reference model to extract similarity and difference.

### Technical Solution

One aspect of the present invention provides a system for analyzing a lifestyle including a log collecting unit, a reference model storing unit, a pattern extracting unit, a tendency analyzing unit, and a personalized model generating unit.

The log collecting unit may collect lifelogs of multiple users. The reference model storing unit may store a reference model generated by analyzing a behavior sequence based on the collected lifelogs. The pattern extracting unit may extract similar behavior patterns by mining data in the stored reference model by using the lifelogs collected from the users in real time. The tendency analyzing unit may analyze a user's tendency by using the extracted similar behavior patterns. The personalized model generating unit may generate a personalized lifestyle model based on the analyzed user's tendency.

Further, the lifelogs may include at least one of private data, public data, personal data, anonymous data, connected data, and sensor data.

Further, the reference model storing unit may extract the behavior sequences in the collected lifelog, analyze similarity between the extracted behavior sequences, and align behavior sequences with high similarity by using a sequence alignment method to store the behavior sequences with high similarity as an ontology type reference model in which the behavior sequences with high similarity are connected to each other in a tree form.

Further, the reference model storing unit may store the aligned reference model by analyzing the similarity between the extracted behavior sequences by using at least one of whether the behavior sequences occurs within a predetermined time and whether information included in the behavior sequences is the same.

Further, the tendency analyzing unit may analyze the user's tendency by comparing data of the lifelogs collected from the users with data which may be obtained based on the reference model storing expert knowledge data and experience data analyzed based on experience of multiple users under the same input condition to extract similarity and difference.

Further, the tendency analyzing unit may analyze an individual tendency by analyzing activity information in an individual social network included in the collected lifelog.

Meanwhile, another aspect of the present invention provides a method for analyzing a lifestyle including collecting a log, storing a reference model, extracting a pattern, analyzing a tendency, and generating a personalized model.

In the collecting of the log, lifelogs of multiple users may be collected. In the storing of the reference model, a reference model generated by analyzing a behavior sequence based on the collected lifelogs may be stored. In the extracting of the pattern, similar behavior patterns may be extracted by mining data in the stored reference model by using the lifelogs collected from the users in real time. In the analyzing of the tendency, a user's tendency may be analyzed by using the extracted similar behavior patterns. In the generating of the personalized model, a personalized lifestyle model may be generated based on the analyzed user's tendency.

Further, the lifelogs may include at least one of private data, public data, personal data, anonymous data, connected data, and sensor data.

Further, in the storing of the reference model, the behavior sequences with high similarity may be stored as an ontology type reference model in which the behavior sequences with high similarity are connected to each other in a tree form by extracting the behavior sequences in the collected lifelog, analyzing similarity between the extracted behavior sequences, and aligning behavior sequences with high similarity by using a sequence alignment method.

Further, in the storing of the reference model storing unit, the aligned reference model may be stored by analyzing the similarity between the extracted behavior sequences by using at least one of whether the behavior sequences occurs within a predetermined time and whether information included in the behavior sequences is the same.

Further, in the analyzing of the tendency, the user's tendency may be analyzed by comparing data of the lifelogs collected from the users with data which may be obtained based on the reference model storing expert knowledge data and experience data analyzed based on experience of multiple users under the same input condition to extract similarity and difference.

Further, in the analyzing of the tendency, an individual tendency may be analyzed by analyzing activity information in an individual social network included in the collected lifelog.

### Advantageous Effects

According to the present invention, by collecting lifelogs of multiple users, storing a reference model generated by analyzing a behavior sequence based on the collected lifelogs, extracting similar behavior patterns by mining data in the stored reference model by using the lifelogs collected from the users in real time, analyzing a user's tendency by using the extracted similar behavior patterns, and generating a personalized lifestyle model based on the analyzed user's tendency, a user or an expert may generate the reference model by using the collected lifelog without directly setting the behavior sequence, and the reference model may be properly changed according to data accumulated with time to be evolved over time.

Further, in the analyzing of the tendency, the user's tendency is analyzed by comparing data of the lifelogs collected from the users with data which may be obtained based on the reference model storing expert knowledge data and experience data analyzed based on experience of multiple users under the same input condition to extract similarity and difference, and thus the personalized model may be more easily generated.

### DESCRIPTION OF DRAWINGS

FIG. 1 is a diagram illustrating a configuration of an autonomous lifestyle care system according to an exemplary embodiment of the present invention.

FIG. 2 is a diagram illustrating a configuration of a reference modeling device for modeling a generalized lifestyle according to the exemplary embodiment of the present invention.

FIG. 3 is a diagram illustrating a configuration of a personalized modeling device for modeling a personalized lifestyle according to the exemplary embodiment of the present invention.

FIG. 4 is a flowchart illustrating a process of managing the lifestyle in the autonomous lifestyle care system according to the exemplary embodiment of the present invention.

FIG. 5 is a flowchart illustrating a process of generating a reference model in the reference modeling device according to the exemplary embodiment of the present invention.

FIG. 6 is a flowchart illustrating a process of generating a personalized lifestyle model in the personalized modeling device according to the exemplary embodiment of the present invention.

FIG. 7 is a diagram illustrating an example of the reference model generated according to the exemplary embodiment of the present invention.

FIG. 8 is a diagram illustrating a configuration of a system for analyzing a lifestyle according to another exemplary embodiment of the present invention.

FIG. 9 is a flowchart of a method for analyzing a lifestyle according to yet another exemplary embodiment of the present invention.

FIG. 10 is a diagram illustrating an example of the reference model generated according to the exemplary embodiment of the present invention.

FIG. 11 is a diagram illustrating another example of the reference model generated according to the exemplary embodiment of the present invention.

### BEST MODE OF THE INVENTION

One aspect of the present invention provides a system for analyzing a lifestyle including a log collecting unit, a reference model storing unit, a pattern extracting unit, a tendency analyzing unit, and a personalized model generating unit.

The log collecting unit may collect lifelogs of multiple users. The reference model storing unit may store a reference model generated by analyzing a behavior sequence based on the collected lifelogs. The pattern extracting unit may extract similar behavior patterns by mining data in the stored reference model by using the lifelogs collected from the users in real time. The tendency analyzing unit may analyze a user's tendency by using the extracted similar behavior patterns. The personalized model generating unit may generate a personalized lifestyle model based on the analyzed user's tendency.

Further, the lifelogs may include at least one of private data, public data, personal data, anonymous data, connected data, and sensor data.

Further, the reference model storing unit may extract the behavior sequences in the collected lifelog, analyze similarity between the extracted behavior sequences, and align behavior sequences with high similarity by using a sequence alignment method to store the behavior sequences with high similarity as an ontology type reference model in which the behavior sequences with high similarity are connected to each other in a tree form.

Further, the reference model storing unit may store the aligned reference model by analyzing the similarity between the extracted behavior sequences by using at least one of whether the behavior sequences occurs within a predetermined time and whether information included in the behavior sequences is the same.

Further, the tendency analyzing unit may analyze the user's tendency by comparing data of the lifelogs collected from the users with data which may be obtained based on the reference model storing expert knowledge data and experience data analyzed based on experience of multiple users under the same input condition to extract similarity and difference.

Further, the tendency analyzing unit may analyze an individual tendency by analyzing activity information in an individual social network included in the collected lifelog.

Meanwhile, another aspect of the present invention provides a method for analyzing a lifestyle including collecting a log, storing a reference model, extracting a pattern, analyzing a tendency, and generating a personalized model.

In the collecting of the log, lifelogs of multiple users may be collected. In the storing of the reference model, a reference model generated by analyzing a behavior sequence based on the collected lifelogs may be stored. In the extracting of the pattern, similar behavior patterns may be extracted by mining data in the stored reference model by using the lifelogs collected from the users in real time. In the analyzing of the tendency, a user's tendency may be analyzed by using the extracted similar behavior patterns. In the generating of the personalized model, a personalized lifestyle model may be generated based on the analyzed user's tendency.

Further, the lifelogs may include at least one of private data, public data, personal data, anonymous data, connected data, and sensor data.

Further, in the storing of the reference model, the behavior sequences with high similarity may be stored as an ontology type reference model in which the behavior sequences with high similarity are connected to each other in a tree form by extracting the behavior sequences in the collected lifelog, analyzing similarity between the extracted behavior sequences, and aligning behavior sequences with high similarity by using a sequence alignment method.

Further, in the storing of the reference model storing unit, the aligned reference model may be stored by analyzing the similarity between the extracted behavior sequences by using at least one of whether the behavior sequences occurs within a predetermined time and whether information included in the behavior sequences is the same.

Further, in the analyzing of the tendency, the user's tendency may be analyzed by comparing data of the lifelogs collected from the users with data which may be obtained based on the reference model storing expert knowledge data and experience data analyzed based on experience of multiple users under the same input condition to extract similarity and difference.

Further, in the analyzing of the tendency, an individual tendency may be analyzed by analyzing activity information in an individual social network included in the collected lifelog.

### [Modes of the Invention]

Other objects and features than the above-described object will be apparent from the description of exemplary embodiments with reference to the accompanying drawings.

Hereinafter, exemplary embodiments of the present invention will be described in detail with reference to the accompanying drawings. Further, in the following description, a detailed explanation of known related technologies may be omitted to avoid unnecessarily obscuring the subject matter of the present invention.

However, the present invention is not restricted or limited to the exemplary embodiments. Like reference numerals illustrated in the respective drawings designate like members.

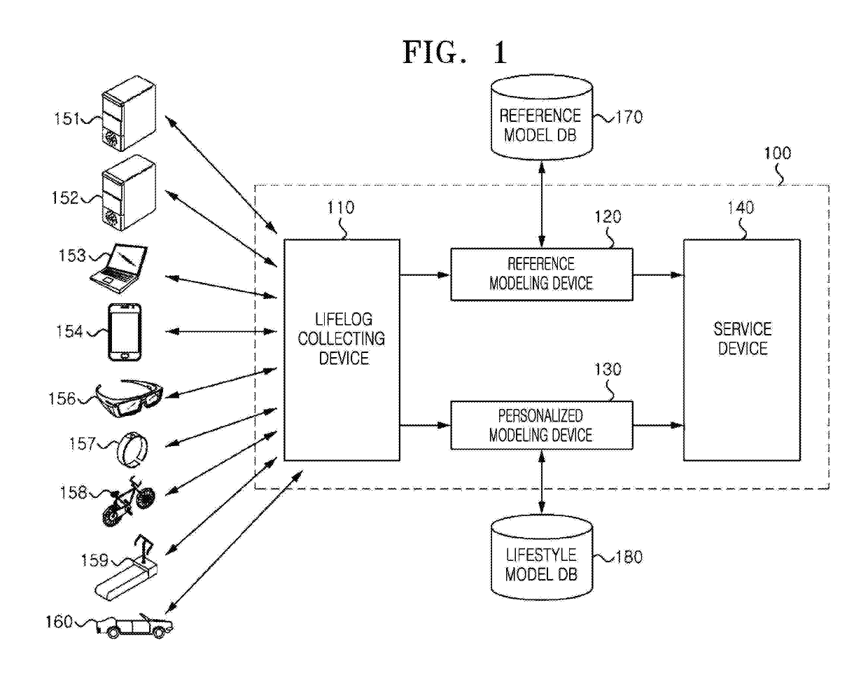

Hereinafter, autonomous lifestyle care system and method according to an exemplary embodiment of the present invention will be described in detail with reference to FIGS. 1 to 7.

FIG. 1 is a diagram illustrating a configuration of an autonomous lifestyle care system according to an exemplary embodiment of the present invention.

Referring to FIG. 1, an autonomous lifestyle care system 100 may include a lifelog collecting device 110, a reference modeling device 120, a personalized modeling device 130, and a service device 140.

The lifelog collecting device 110 may collect the lifelog by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data.

Here, the private data may include a calendar, an address book, credit card details, medical records, shopping details, call records, text records, bank records, stock trading records, various financial transaction records, and the like.

The public data may include traffic information, weather information, various statistical data, and the like.

The personal data may include favorites, search records, social networking service (SNS) conversation records, download records, blog records, and the like.

The anonymous data may include topic information (trend of public opinion) issued in the SNS, news, real-time keyword ranking, and the like.

The connected data may include records connected with a home or a vehicle and the like and for example, include occupancy detection, RFID (individual identification and access records), digital door locks, smart applications (use information), home network use records, Internet use records (access point), a car navigation system (movement path, etc.), a black box (video and audio records), tachographs (driving time, driving patterns, etc.).

The sensor data may include data measured through a dedicated device, an environmental sensor, a smart device, medical equipment, personal exercise equipment, a personal activity measuring device, and the like.

Here, the dedicated device may include a calorie measuring device, a position measuring device, a thermometer, a stress measuring device, an oral bad breath measuring device, a breathalyzer, distance/speed, GPS-based position measuring device, an apnea measuring device, a snoring measuring device, and the like.

The environment sensor may include a temperature sensor, a humidity sensor, a luminance sensor, CCTVs (streets, public transports, buildings, etc.), a carbon dioxide measuring sensor, an ozone measuring sensor, a carbon monoxide measuring sensor, a dust measuring sensor, a UV measuring sensor, and the like.

The smart device includes a smart phone, a head-mounted display (Google Glass, etc.), and a smart watch (Apple iWatch, etc.), and may acquire data such application payment details, often used applications, application usage details, GPS (location), recorded videos, audios, photos, and favorite music, and the like.

The medical equipment may include an electronic balance, a body fat measuring device, a diabetes measuring device, a heart rate measuring device, a blood pressure measuring device, and the like, and the measured data may include sensor data.

The personal exercise equipment may include exercise equipment capable of measuring an exercising amount such as sensors attached with a running machine, a bicycle, and running shoes, and the exercising amount measured from the exercise equipment may include sensor data.

Meanwhile, the lifelog collecting device 110 may be constituted by a separate device, but may be included in the reference modeling device 120 or the personalized modeling device 130.

The reference modeling device 120 receives the lifelog collected from the lifelog collecting device 110 and generates a reference model by using the collected lifelog.

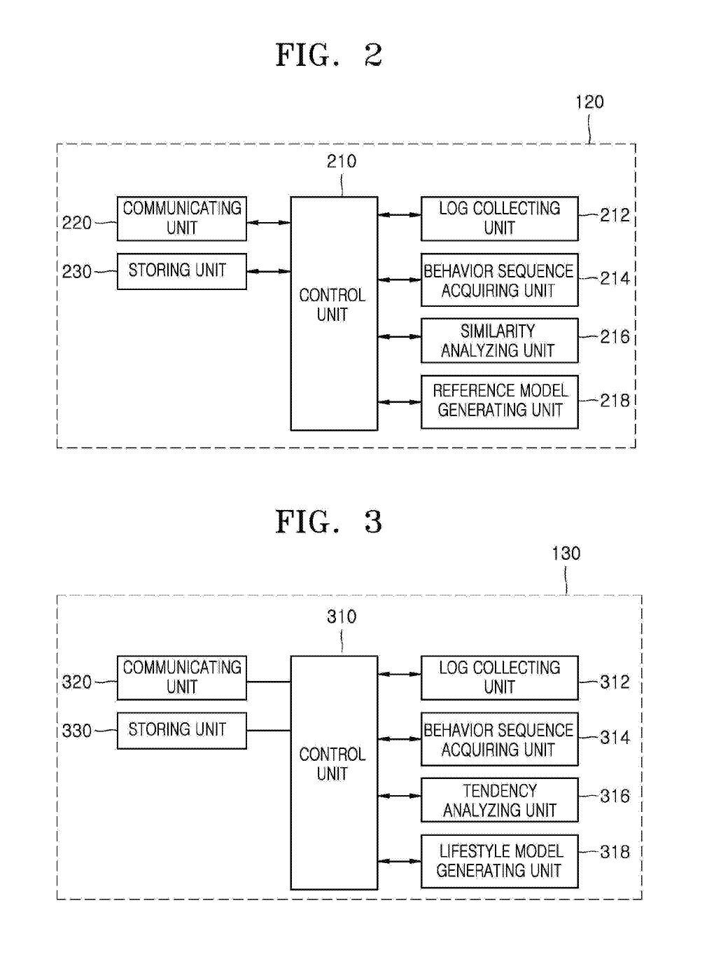

In this case, the reference modeling device 120 may extract behavior sequences in the collected lifelog, analyze similarity between the extracted behavior sequences, and align the behavior sequences by using a sequence alignment method to generate the reference model. A more detailed description of the reference modeling device 120 will be described below with reference to FIG. 2.

The personalized modeling device 130 receives the lifelog collected from the lifelog collecting device 110, analyzes an individual tendency by using the collected lifelog, and generates a personalized lifestyle model for each tendency.

The personalized modeling device 130 may extract a behavior pattern which is repeated more than a predetermined number of times for each individual by using a data mining method in the collected lifelog as the individual behavior sequence, analyzes the individual tendency by analyzing activity information in an individual social network included in the collected lifelog, and generate the personalized lifestyle model for each tendency by connecting behavior sequences of users having similar tendencies. A more detailed description of the personalized modeling device 130 will be described below with reference to FIG. 3.

The reference model generated in the reference modeling device 120 in the reference modeling device 120 and the personalized lifestyle model generated in the personalized modeling device 130 tend to be more accurate as the lifelogs are more and more accumulated. Accordingly, the reference model and the personalized lifestyle model automatically reflect the behavior sequences that may vary according to the age as time passes to be evolved over time.

Meanwhile, the reference model generated in the reference modeling device 120 in the reference modeling device 120 and the personalized lifestyle model generated in the personalized modeling device 130 may be united for the service to be provided to the service device 140.

The service device 140 estimates a possible user's behavior based on current information of the user which is collected by using the reference model received from the reference modeling device 120 and the personalized lifestyle model received from the personalized modeling device 130 and verifies whether the estimated user's behavior has a bad effect on the user's health.

As the verified result, when the estimated user's behavior has the bad effect on the user's health, the service device 140 may induce the user to avoid the estimated user's behavior. In this case, the service device 140 may use a direct method and an indirect method as the method of avoiding the estimated user's behavior.

The direct method is a method in which the user directly recognizes and avoids the possible behavior by transmitting the possible user's behavior to the user.

The indirect method as an unobtrusive method is a method of avoiding the user's behavior from occurring in advance by indicating any behavior to the user. Accordingly, in the indirect method, the user may not recognize the possible behavior.

For example, when verifying the personalized lifestyle model of any user, in the case of having a behavior sequence in which the user overeats meat in a meat restaurant on the way home when the user feels bad, if the user's current state is in a bad state, the user is on the way home from work, and the weight of the current user is obese, the user may be induced to avoid the behavior of overeating the meat by recommending a different path without the meat restaurant.

Further, in the case of additionally having a behavior sequence in which the user feels good when the user walks on the flower way, the user may be induced to change the user's feeling by providing the work-off path via the flower way.

FIG. 2 is a diagram illustrating a configuration of a reference modeling device modeling a generalized lifestyle according to the exemplary embodiment of the present invention.

Referring to FIG. 2, the reference modeling device 120 may include a control unit 210, a log collecting unit 212, a behavior sequence acquiring unit 214, a similarity analyzing unit 216, a reference model generating unit 218, a communicating unit 220, and a storing unit 230.

The communicating unit 220 transmits and receives data in wired manner or wirelessly as a communication interface device including a receiver and a transmitter. The communicating unit 220 may communicate with the lifelog collecting device 110, the service device 140, and the reference model DB 170 and directly communicates with a device of providing the lifelog to receive the lifelog.

The storing unit 230 may store an operating system for controlling the overall operation of the reference modeling device 120, application programs, and the like and further store the collected lifelog and the generated reference model according to the present invention. In this case, the storing unit 230 may be a storage device including a flash memory, a hard disk drive, and the like.

The log collecting unit 212 may receive the lifelog or receive the lifelog collected in the lifelog collecting device 110 through the communicating unit 220.

The behavior sequence acquiring unit 214 extracts the behavior sequences in the collected lifelog.

In more detail, the behavior sequence acquiring unit 214 extracts the behavior sequence having at least one of a stimulation idea, a recognition, an emotion, a behaviors, and a result in the collected lifelog by using a data mining method. In this case, the behavior sequence having the stimulation idea, the recognition, the emotion, the behaviors, and the result may be expressed like examples of Table 1.

TABLE 1

| Stimulation | | | | |
|---|---|---|---|---|
| Idea | Recognition | Emotion | Behaviors | Result |
| Thtreat | Danger | Fear, terror | Running, or | Protection |
| | | | flying away | |
| Obstacle | Enemy | Anger, rage | Biting, | Destruction |
| | | | hitting | |
| Potential | Possess | Joy, ecstasy | Courting, | Reproduction |
| Mate | | | mating | |
| Loss of | Isolation | Sadness, | Crying for | Reintegration |
| valued | | greif | help | |
| person | | | | |
| Gruesome | Poison | Disgust, | Vomiting, | Rejection |
| object | | loathing | pushing | |
| | | | away | |
| Group | Friend | Acceptance, | Grooming, | Affiliation |
| member | | trust | sharing | |
| New | What's out | Anticipation | Examining, | Exploration |
| territory | there? | | mapping | |
| Sudden | What is it? | Surprise | Stopping, | Orientation |
| novel | | | alerting | |
| object | | | | |

The behavior sequence acquiring unit 214 may extract the behavior sequence in the collected lifelog, but may also receive the behavior sequence from a user or an expert (a psychologist, etc.).

The similarity analyzing unit 216 analyzes similarity between the behavior sequences acquired through the behavior sequence acquiring unit 214.

In more detail, the similarity analyzing unit 216 may evaluate the similarity between the extracted behavior sequences by using at least one of whether the behavior sequence occurs within a predetermined time and whether information included in the behavior sequence is the same.

The reference model generating unit 218 aligns the behavior sequences by using a sequence alignment method to generate the reference model.

In more detail, the reference model generating unit 218 connects behavior sequences having high similarity in a tree form by using the similarity of the extracted behavior sequences to generate an ontology type reference model.

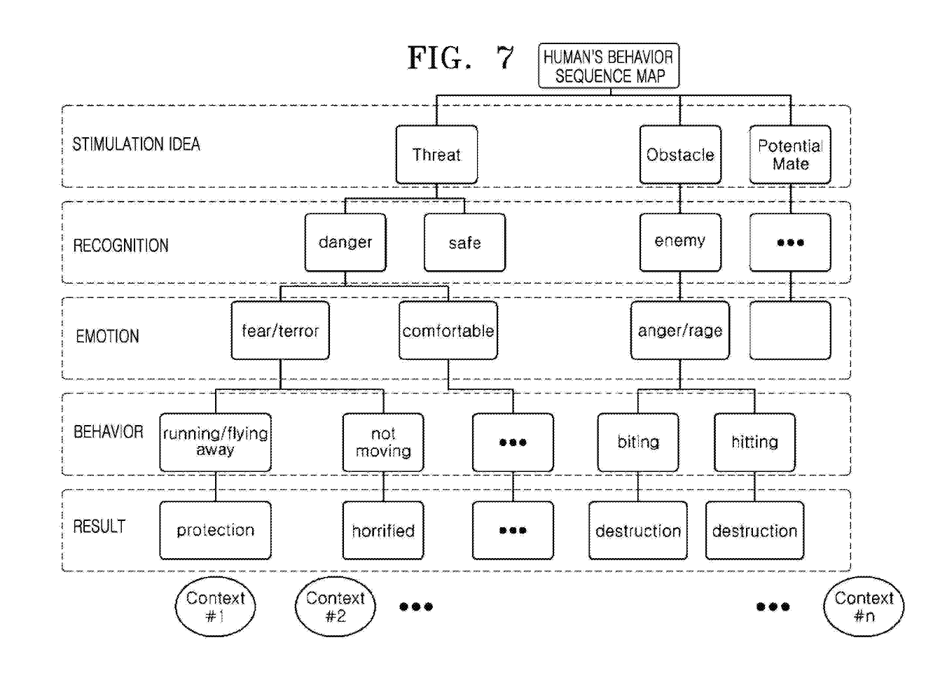

FIG. 7 is a diagram illustrating an example of the reference model generated according to the exemplary embodiment of the present invention.

FIG. 7 is an example of generating the behavior sequence in Table 1 as the reference model, and referring to FIG. 7, it can be seen that the reference model is constituted by a tree type ontology model.

A sequence alignment technique applied to the reference model generating unit 218 is a method which is frequently used in the similarity analysis of base sequences in a bioinformatics field and may be modified and applied to the prevent invention like the following Table 2.

TABLE 2

| | | Sequence Alignment |
|---|---|---|
| | | (Examples applied to |
| | Sequence Alignment | present invention) |
| Description | Method of analyzing | Method of analyzing |
| | similarity between | similarity between |
| | base sequences | behavior sequences |
| Comparison | Reference sequence | Bottom up build by using |
| | | algorithm in which path |
| | | extraction is possible like |
| | | decision tree |
| | read | Behavior occurring in |
| | | predetermined time |
| | | window |
| | Similar species/ | Classification through |
| | neighboring species | Human profiling |
| | mismatch | Diversity of behavior |
| | | patterns according to |
| | | human/time/place |

The control unit 210 may control the overall operation of the reference modeling device 120. In addition, the control unit 210 may perform functions of the log collecting unit 212, the behavior sequence acquiring unit 214, the similarity analyzing unit 216, and the reference model generating unit 218. The control unit 210, the log collecting unit 212, the behavior sequence acquiring unit 214, the similarity analyzing unit 216, and the reference model generating unit 218 are separately illustrated to describe the respective functions. Accordingly, the control unit 210 may include at least one processor configured to perform the respective functions of the log collecting unit 212, the behavior sequence acquiring unit 214, the similarity analyzing unit 216, and the reference model generating unit 218. Further, the control unit 210 may include at least one processor configured to perform some of the respective functions of the log collecting unit 212, the behavior sequence acquiring unit 214, the similarity analyzing unit 216, and the reference model generating unit 218.

FIG. 3 is a diagram illustrating a configuration of a personalized modeling device modeling a personalized lifestyle according to the exemplary embodiment of the present invention.

Referring to FIG. 3, the personalized modeling device 130 may include a control unit 310, a log collecting unit 312, a behavior sequence acquiring unit 314, a tendency analyzing unit 316, a lifestyle model generating unit 318, a communicating unit 320, and a storing unit 330.

The communicating unit 320 transmits and receives data in wired manner or wirelessly as a communication interface device including a receiver and a transmitter. The communicating unit 320 may communicate with the lifelog collecting device 110, the service device 140, and the reference model DB 180 and may directly communicate with a device of providing the lifelog to receive the lifelog.

The storing unit 330 may store an operating system for controlling the overall operation of the personalized modeling device 130, application programs, and the like and further store the collected lifelog and the generated personalized lifestyle model according to the present invention. In this case, the storing unit 330 may be a storage device including a flash memory, a hard disk drive, and the like.

The log collecting unit 312 may receive the lifelog or receive the lifelog collected in the lifelog collecting device 110 through the communicating unit 320.

The behavior sequence acquiring unit 314 extracts individual behavior sequences in the collected lifelog. In more detail, the behavior sequence acquiring unit 314 retrieves the behavior pattern which is repeated more than a predetermined number of times for each individual in the collected lifelog by using the data mining method to extract the retrieved behavior pattern as the individual behavior sequence.

Meanwhile, the behavior sequence acquiring unit 314 may extract the behavior sequence in the collected lifelog, but may also receive the behavior sequence from a user or an expert (a psychologist, etc.).

The tendency analyzing unit 316 analyzes the individual tendency by using the collected lifelog. In more detail, the tendency analyzing unit 316 analyzes the individual tendency by determining interest, taste, and activity of each individual in activity information in the individual social network included in the collected lifelog. In this case, the activity information in the social network may include the number of access times to the social network, visited objects, the number of registered friends, the number of times of postings, the number of times of responses, analysis of the posting contexts, and the like.

The behavior sequence acquiring unit 314 and the tendency analyzing unit 316 may use Hadoop and MapReduce techniques as distributed computing techniques for analyzing a large lifelog. That is, the behavior sequence acquiring unit 314 and the tendency analyzing unit 316 stores and manages the individual behavior sequence through a Hadoop system and may distributed-process an analysis technique through MapReduce.

The lifestyle model generating unit 318 generates the personalized lifestyle model for each tendency by connecting the behavior sequences of the users having similar tendencies.

In more detail, the lifestyle model generating unit 318 analyzes similarity between the behavior sequences of the users having similar tendencies and may generate an ontology type personalized lifestyle model for each tendency by connecting the behavior sequences with high similarity in a tree form.

Meanwhile, the individual uses a specific heuristic for his determination or behavior, and verification of conformity of the individual lifestyle model is required by using the heuristic.

In the verification of conformity of the individual lifestyle model, an individual heuristic is determined by using the individual heuristic which is already devised by psychologists and physiologists. As a method for determining the individual heuristic, conformity of the individual heuristic and the individual lifestyle model may be verified by using question investigation and the like.

In addition, the individual lifestyle model may be readjusted by determining association between the individual lifestyle model and the heuristic of the user, determining conformity of the individual lifestyle model base on the heuristic (in association with the psychologist and the physiologist), and analyzing the heuristic.

However, a method of minimizing intervention of the user or the expert is preferably a method of verifying the conformity of the individual lifestyle model by estimating the individual heuristic through existing accumulated behavior sequences and the individual lifestyle model and retrieving the behavior sequences of the users having the same or similar heuristic to draw similar patterns between the individual lifestyle models.

The control unit 310 may control the overall operation of the personalized modeling device 130. In addition, the control unit 310 may perform functions of the log collecting unit 312, the behavior sequence acquiring unit 314, the tendency analyzing unit 316, and the lifestyle model generating unit 318. The control unit 310, the log collecting unit 312, the behavior sequence acquiring unit 314, the tendency analyzing unit 316, and the lifestyle model generating unit 318 are separately illustrated to describe the respective functions. Accordingly, the control unit 310 may include at least one processor configured to perform the respective functions of the log collecting unit 312, the behavior sequence acquiring unit 314, the tendency analyzing unit 316, and the lifestyle model generating unit 318. Further, the control unit 310 may include at least one processor configured to perform the respective functions of the log collecting unit 312, the behavior sequence acquiring unit 314, the tendency analyzing unit 316, and the lifestyle model generating unit 318.

Hereinafter, a method of managing the lifestyle in the autonomous lifestyle care system will be described below with reference to the accompanying drawings.

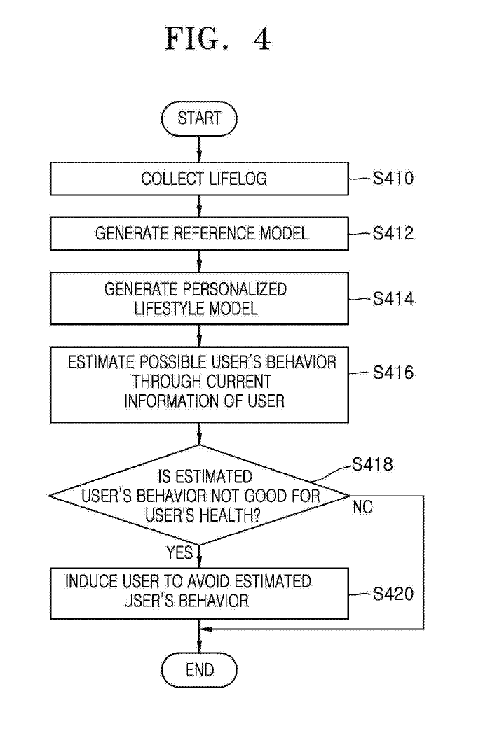

FIG. 4 is a flowchart illustrating a process of managing the lifestyle in the autonomous lifestyle care system according to the exemplary embodiment of the present invention.

Referring to FIG. 4, an autonomous lifestyle care system 100 collects the lifelog including at least one of private data, public data, personal data, anonymous data, connected data, and sensor data (S410).

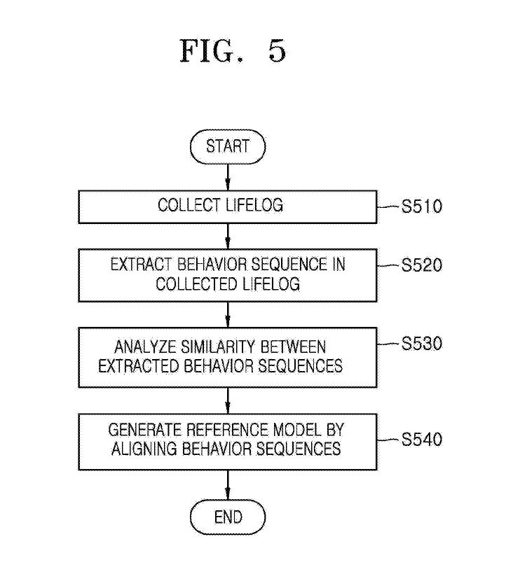

In addition, the autonomous lifestyle care system 100 generates the reference model by using the collected lifelog (S412). In this case, the autonomous lifestyle care system 100 may extract behavior sequences in the collected lifelog, analyze similarity between the extracted behavior sequences, and align the behavior sequences by using a sequence alignment method to generate the reference model. The generating of the reference model will be described below in more detail with reference to FIG. 5.

In addition, the autonomous lifestyle care system 100 analyzes an individual tendency by using the collected lifelog and generates a personalized lifestyle model for each tendency (S414).

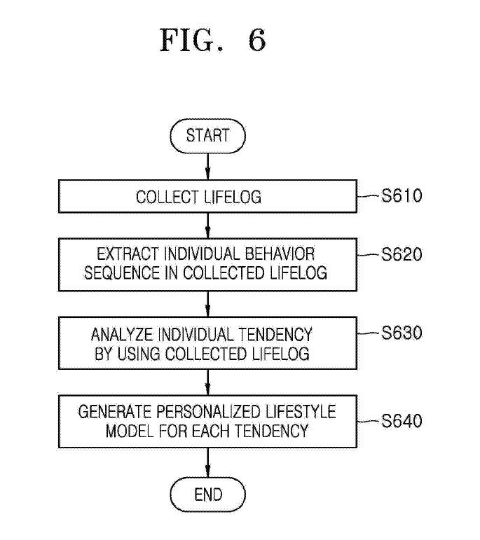

In this case, the autonomous lifestyle care system 100 may extract a behavior pattern which is repeated more than a predetermined number of times for each individual by using a data mining method in the collected lifelog as the individual behavior sequence, analyzes the individual tendency by analyzing activity information in an individual social network included in the collected lifelog, and generate the personalized lifestyle model for each tendency by connecting behavior sequences of users having similar tendencies. The generating of the personalized lifestyle model will be described below in more detail with reference to FIG. 6.

In addition, the autonomous lifestyle care system 100 estimates a possible user's behavior by reflecting user's current information which is collected in the reference model and the lifestyle model (S416).

In addition, the autonomous lifestyle care system 100 verifies whether the estimated user's behavior has a bad effect on the user's health (S418).

As verified in step S418, when the estimated user's behavior has the bad effect on the user's health, the autonomous lifestyle care system 100 induces the user to avoid the estimated user's behavior (S420).

In this case, the autonomous lifestyle care system 100 may transmit the possible user's behavior to the user in order to induce the user to avoid the estimated user's behavior or prevent the user's behavior from occurring by indicating any behavior to the user.

FIG. 5 is a flowchart illustrating a process of generating a reference model in the reference modeling device according to the exemplary embodiment of the present invention.

Referring to FIG. 5, the reference modeling device 120 collects the lifelog including at least one of private data, public data, personal data, anonymous data, connected data, and sensor data (S510).

In addition, the reference modeling device 120 extracts the behavior sequence in the collected lifelog (S520). In this case, the reference modeling device 120 may extract the behavior sequence having at least one of stimulation idea, recognition, emotion, behavior, and result in the collected lifelog by using a data mining method.

In addition, the reference modeling device 120 analyzes similarity between the extracted behavior sequences (S530). In this case, the reference modeling device 120 may evaluate and analyze the similarity between the extracted behavior sequences by using at least one of whether the behavior sequence occurs within a predetermined time and whether information included in the behavior sequence is the same.

In addition, the reference model generating unit 120 aligns the behavior sequences by using a sequence alignment method to generate the reference model (S540). In this case, the reference model generating unit 120 connects behavior sequences having high similarity in a tree form by using the similarity of the extracted behavior sequences to generate an ontology type reference model.

FIG. 6 is a flowchart illustrating a process of generating a personalized lifestyle model in the personalized modeling device according to the exemplary embodiment of the present invention.

Referring to FIG. 6, the personalized modeling device 130 collects the lifelog including at least one of private data, public data, personal data, anonymous data, connected data, and sensor data (S610).

In addition, the personalized modeling device 130 extracts the individual behavior sequence in the collected lifelog (S620). In this case, the personalized modeling device 130 may extract the behavior pattern which is repeated more than a predetermined number of times as the individual behavior sequence for each individual in the collected lifelog by using the data mining method.

In addition, the personalized modeling device 130 extracts the individual tendency by using the collected lifelog (S630). In this case, the personalized modeling device 130 may analyze the individual tendency by analyzing activity information in the individual social network included in the collected lifelog.

In addition, the personalized modeling device 130 generates the personalized lifestyle model for each tendency by connecting the behavior sequences of the users having similar tendencies (S640). In this case, the personalized modeling device 130 analyzes similarity between the behavior sequences of the users having similar tendencies and may generate an ontology type personalized lifestyle model for each tendency by connecting the behavior sequences with high similarity in a tree form.

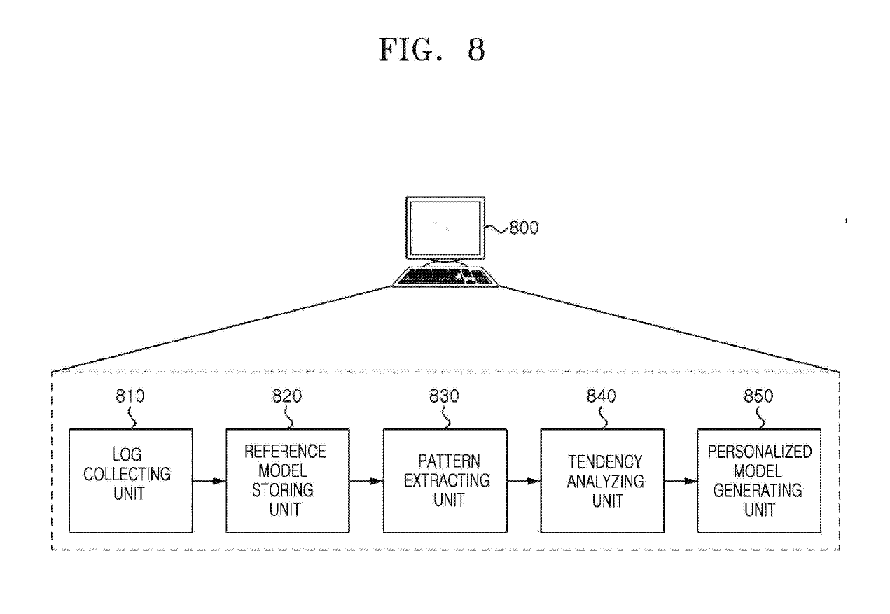

FIG. 8 is a diagram illustrating a configuration of a system for analyzing a lifestyle according to another exemplary embodiment of the present invention.

Before the description, a system 800 for analyzing a lifestyle of FIG. 8 may be a system included in the autonomous lifestyle care system 100 according to the exemplary embodiment of the present invention illustrated in FIG. 1.

Further, according to the exemplary embodiment of the present invention described above, the process of generating the reference model and the process of generating the personalized lifestyle models are generated independently or in parallel by using the respectively collected lifelogs. However, in the system for analyzing the lifestyle illustrated in FIG. 8, the personalized lifestyle model may be generated by referring to the reference model.

Referring to FIG. 8, the system 800 for analyzing the lifestyle according to the exemplary embodiment of the present invention includes a log collecting unit 810, a reference model storing unit 820, a pattern extracting unit 830, a tendency analyzing unit 840, and a personalized model generating unit 850.

The log collecting unit 810 collects lifelogs of multiple users and the lifelog collecting device 110 collects the lifelogs by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data, and the more detailed description thereof is described above and thus will be omitted below.

The reference model storing unit 820 stores the generated reference model by analyzing the behavior sequence based on the lifelog collected in the log collecting unit 810.

In this case, the reference model storing unit 820 may store the behavior sequences with high similarity as an ontology type reference model in which the behavior sequences with high similarity are connected to each other in a tree form by extracting the behavior sequences in the collected lifelog, analyzing similarity between the extracted behavior sequences, and aligning behavior sequences with high similarity by using a sequence alignment method.

Further, the reference model storing unit 820 may store the aligned reference model by analyzing the similarity between the extracted behavior sequences by using at least one of whether the behavior sequences occurs within a predetermined time and whether information included in the behavior sequences is the same.

The reference model storing unit 820 may store the reference model generated from the reference modeling device 120 of FIG. 2 described above. In this case, the process of generating the reference model in the reference modeling device 120 is described in detail with reference to FIG. 2 and will be referred.

FIG. 7 is a diagram illustrating an example of the reference model generated according to the exemplary embodiment of the present invention. The more detailed description thereof is described above and thus, will be omitted below.

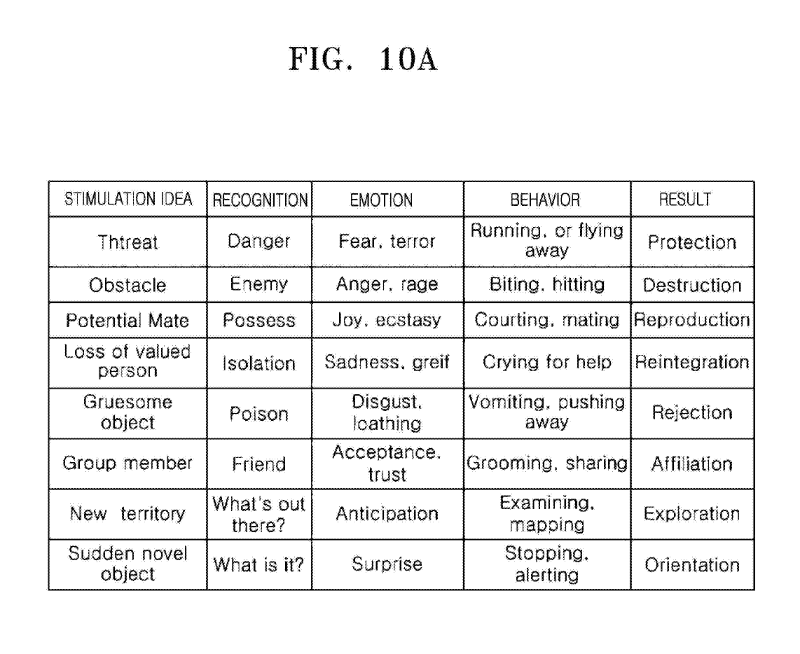

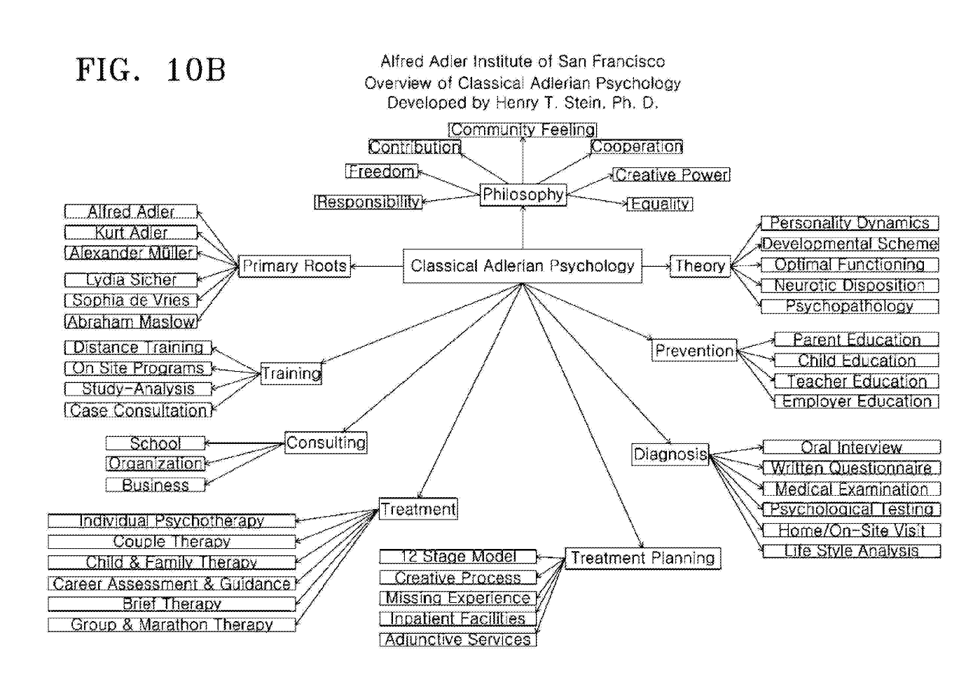

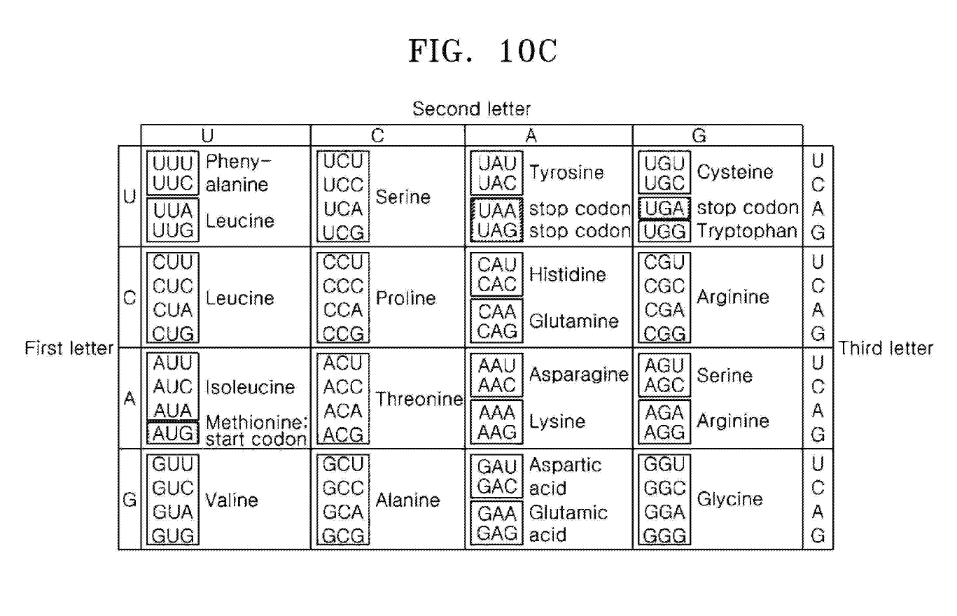

Further, FIG. 10 is a diagram illustrating an example of the reference model generated according to the exemplary embodiment of the present invention and will be simply described with reference to the description of FIG. 2.

Referring to FIG. 10, the reference model storing unit 820 extracts the behavior sequence having at least one of a stimulation idea, recognition, an emotion, a behavior, and a result in the collected lifelog by using a data mining method. In this case, the behavior sequence having the stimulation idea, the recognition, the emotion, the behaviors, and the result may be expressed like FIG. 10A. In addition, the reference model storing unit 820 analyzes similarity by using the behavior sequence to configure the behavior sequence with high similarity as a tree type ontology model like FIG. 10B and stores an indexing node type reference model like FIG. 10C based on the behavior sequence.

A sequence alignment method applied in the process of generating the reference model is a method which is frequently used in the similarity analysis of base sequences in a bioinformatics field and may be modified and applied like the above Table 2 as described above.

According to the exemplary embodiment of the present invention, like FIG. 10C, the indexing nodes may be indexed and stored as a base sequence character of modified base sequence information.

Meanwhile, the lifelog collecting device 110 may be constituted by a separate device, but may be included in the reference modeling device 120.

The pattern extracting unit 830 for generating the personalized model by using the lifelog collected from the user in real lime extracts similar behavior patterns by data-mining the lifelog collected from the user in real lime in the reference model in which the lifelogs of the multiple users are stored.

In this case, the extracted similar behavior patterns are extracted in the reference model storing unit 820 including expert knowledge data or experience data which are analyzed based on experience of the multiple users.

The tendency analyzing unit 840 analyzes the user's tendency by using the similar behavior patterns extracted in the pattern extracting unit 830.

Further, the tendency analyzing unit 840 analyzes the user's tendency by comparing data of the lifelogs collected from the users with data which may be obtained based on the reference model storing expert knowledge data and experience data analyzed based on experience of multiple users under the same input condition to extract similarity and difference.

Further, the tendency analyzing unit 840 may also analyze an individual tendency by using activity information in an individual social network included in the lifelog collected in the log collecting unit 810.

The personalized model generating unit 850 generates a personalized lifestyle model based on the user's tendency analyzed in the tendency analyzing unit 840.

The lifelog collected from the user may be data which are similar to the reference model generated based on the lifelog information of the multiple users, that is, a generalized model or may also be significantly different data.

Accordingly, the personalized model generating unit 850 generates the personalized lifestyle model by distinguishing the significantly different data from the data similar to the reference model.

Further, the personalized model generating unit 850 may model different data from the reference model as the personalized lifestyle model and the modeled personalized data may be stored as the reference model in the reference model storing unit 820.

Accordingly, the reference model storing unit 820 may continuously extend the reference model by feed-backing and additionally storing the personalized data with time, that is, generalizing the personalized data.

Further, the personalized model generating unit 850 may generate the personalized model by using the personalized model device 130 illustrated in FIG. 3 and may analyze similarity between the behavior sequences of the users with similar tendencies and generate an ontology type personalized lifestyle model for each tendency by connecting the behavior sequences with high similarity in a tree form. The more detailed description thereof is described above and thus, will be omitted below.

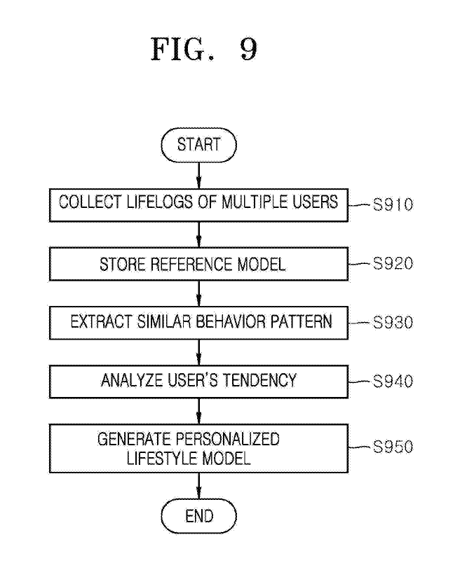

FIG. 9 is a flowchart of a method for analyzing a lifestyle according to yet another exemplary embodiment of the present invention. The method will be briefly described with reference to FIG. 8.

Referring to FIG. 9, step S901 is collecting lifelogs of multiple users, and the log collecting unit 810 collects lifelogs of multiple users. The lifelog collecting device 110 collects the lifelogs of multiple users and collects the lifelogs by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data, and the more detailed description thereof is described above and thus will be omitted below.

Step S920 is storing the reference model, and the reference model storing unit 820 stores the generated reference model by analyzing the behavior sequence based on the lifelog collected in the log collecting unit 810.

In this case, the reference model storing unit 820 may store the behavior sequences with high similarity as an ontology type reference model in which the behavior sequences with high similarity are connected to each other in a tree form by extracting the behavior sequences in the collected lifelog, analyzing similarity between the extracted behavior sequences, and aligning behavior sequences with high similarity by using a sequence alignment method.

The reference model storing unit 820 may store the reference model generated from the reference modeling device 120 of FIG. 2 described above. In this case, the process of generating the reference model in the reference modeling device 120 is described in detail with reference to FIG. 2 and will be referred.

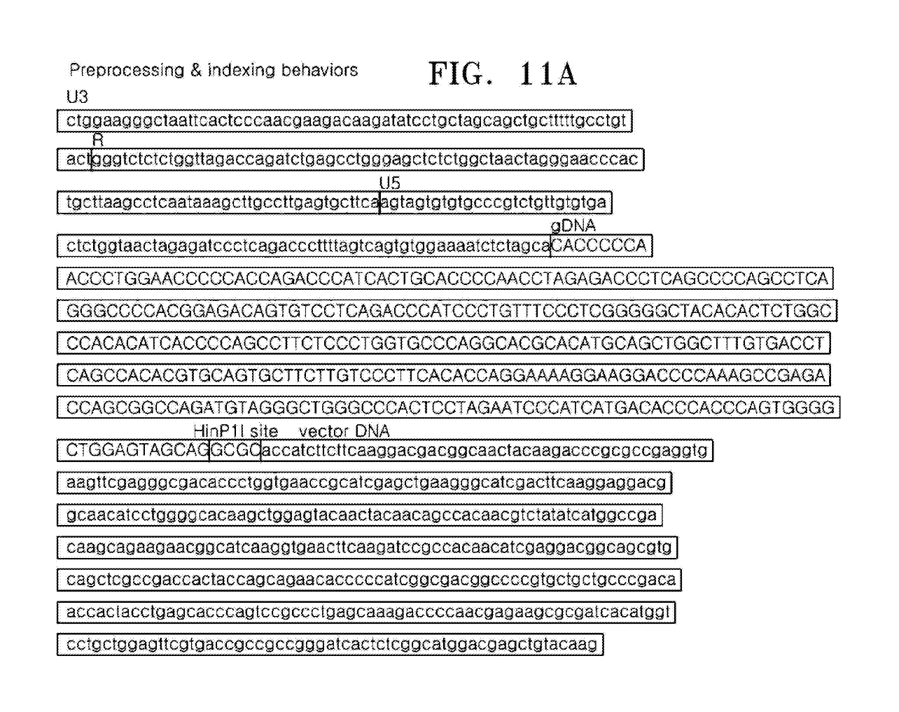

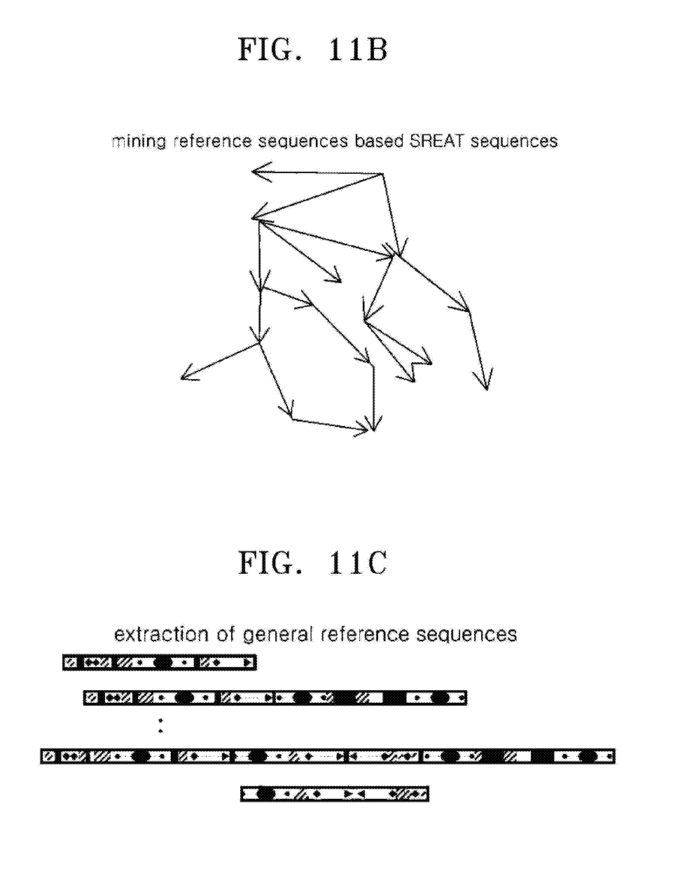

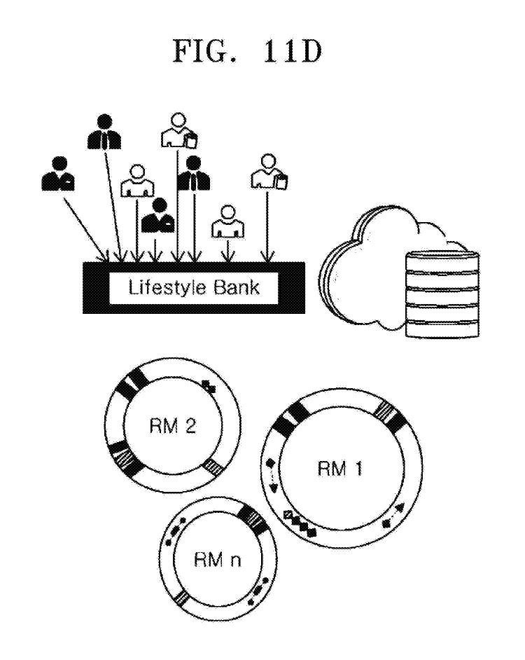

FIG. 11 is a diagram illustrating another example of the reference model generated according to the exemplary embodiment of the present invention.

Referring to FIG. 11, the process of generating the reference model is as follows. The user's behavior is indexed by processing lifelog data of the multiple users collected in the log collecting unit 810 (a), and a correlation of the data is drawn by mining the indexed data (b). A general reference sequence is extracted (c), and the generalized lifestyle model is generated by properly extending the data (d). The generated generalized lifestyle model is the reference model, and the reference model is stored in a lifestyle bank, that is, a storage of the reference model. In other words, the lifestyle bank corresponds to the reference model storing unit 820.

Further, the reference model storing unit 820 may also store information fed-back from the user. Accordingly, the reference model storing unit 820 automatically reflects the behavior sequence which may vary according to the age with time, and thus the behavior sequence is evolved over time.

Step S930 is extracting similar behavior patterns, and the pattern extracting unit 830 for generating the personalized model by using the lifelog collected from the user in real lime extracts similar behavior patterns by data-mining the lifelog collected from the user in real lime in the reference model in which the lifelogs of the multiple users are stored.

In this case, the extracted similar behavior patterns are extracted in the reference model storing unit 820 including expert knowledge data or experience data which are analyzed based on experience of the multiple users.

Step S940 is analyzing the user's tendency, and the tendency analyzing unit 840 analyzes the user's tendency by using the similar behavior patterns extracted in the pattern extracting unit 830.

Further, the tendency analyzing unit 840 analyzes the user's tendency by comparing data of the lifelogs collected from the users with data which may be obtained based on the reference model storing expert knowledge data and experience data analyzed based on experience of multiple users under the same input condition to extract similarity and difference.

Further, the tendency analyzing unit 840 may also analyze an individual tendency by using activity information in an individual social network included in the lifelog collected in the log collecting unit 810.

Step S950 is generating the personalized lifestyle model, and the personalized model generating unit 850 generates a personalized lifestyle model based on the user's tendency analyzed in the tendency analyzing unit 840.

The lifelog collected from the user may be data which are similar to the reference model generated based on the lifelog information of the multiple users, that is, a generalized model or may also be significantly different data.

Accordingly, the personalized model generating unit 850 generates the personalized lifestyle model by distinguishing the significantly different data from the data similar to the reference model.

Further, the personalized model generating unit 850 may generate the personalized model by using the personalized model device 130 illustrated in FIG. 3 and may analyze similarity between the behavior sequences of the users with similar tendencies and generate an ontology type personalized lifestyle model for each tendency by connecting the behavior sequences with high similarity in a tree form.

Further, the personalized model generating unit 850 may model different data from the reference model as the personalized lifestyle model and the modeled personalized data may be stored as the reference model in the reference model storing unit 820.

Accordingly, the reference model storing unit 820 may continuously extend the reference model by feed-backing and additionally storing the personalized data with time, that is, generalizing the personalized data.

The personalized lifestyle model means a lifestyle model for a specific individual which is different from the reference model. For example, when a response to a specific stimulation and a specific motivated factor is beyond a predetermined range or more from any one of a plurality of reference models or difficult to be described even by any one of the plurality of reference models, the personalized lifestyle model may be formed. As the personalized lifestyle model is accumulated, models with high similarity among the separately generated personalized lifestyle models may be drawn. A new reference model may also be drawn by considering an appearance frequency, reproduction probability of a causal relationship, and the like of the plurality of drawn personalized lifestyle models.

The method for analyzing the lifestyle according to the exemplary embodiment of the present invention may be implemented as a program command which may be executed by various computers to be recorded in a computer readable medium. The program command recorded in the medium may be specially designed and configured for the present invention, or may be publicly known to and used by those skilled in the computer software field. An example of the computer readable recording medium includes a magnetic media, such as a hard disk, a floppy disk, and a magnetic tape, an optical media, such as a CD-ROM and a DVD, a magneto-optical media, such as a floptical disk, and a hardware device, such as a ROM, a RAM, a flash memory, an eMMC, specially formed to store and execute a program command. An example of the program command includes a high-level language code executable by a computer by using an interpreter, and the like, as well as a machine language code created by a compiler. The hardware device may be configured to be operated with one or more software modules in order to perform the operation of the present invention, and an opposite situation thereof is available.

The present invention has been described by the specified matters such as specific components and limited exemplary embodiments and drawings, which are provided to help the overall understanding of the present invention and the present invention is not limited to the exemplary embodiments, and those skilled in the art will appreciate that various modifications and changes can be made within the scope without departing from an essential characteristic of the present invention.

Therefore, the spirit of the present invention is defined by the appended claims rather than by the description preceding them, and the claims to be described below and it should be appreciated that all technical spirit which are evenly or equivalently modified are included in the claims of the present invention.

### INDUSTRIAL APPLICABILITY

The present invention relates to a technique of managing a lifestyle, and more particularly, to a technique of analyzing a use's tendency by collecting big data of an personal lifestyle, storing a reference model generated by using the big data, and comparing lifelog data collected from the user based on the stored reference model to extract similarity and difference.

One aspect of the present invention provides a system for analyzing a lifestyle including a log collecting unit, a reference model storing unit, a pattern extracting unit, a tendency analyzing unit, and a personalized model generating unit.

1. A system for analyzing a lifestyle comprising:
a log collecting unit configured to collect lifelogs of multiple users;
a reference model storing unit configured to store a reference model generated by analyzing a behavior sequence based on the collected lifelogs;
a pattern extracting unit configured to extract similar behavior patterns by mining data in the stored reference model by using the lifelogs collected from the users in real time;
a tendency analyzing unit configured to analyze a user's tendency by using the extracted similar behavior patterns; and
a personalized model generating unit configured to generate a personalized lifestyle model based on the analyzed user's tendency.

2. The system for analyzing the lifestyle of claim 1, wherein the lifelogs includes at least one of private data, public data, personal data, anonymous data, connected data, and sensor data.

3. The system for analyzing the lifestyle of claim 1, wherein the reference model storing unit extracts the behavior sequences in the collected lifelog, analyzes similarity between the extracted behavior sequences, and aligns behavior sequences with high similarity by using a sequence alignment method to store the behavior sequences with high similarity as an ontology type reference model in which the behavior sequences with high similarity are connected to each other in a tree form.

4. The system for analyzing the lifestyle of claim 3, wherein the reference model storing unit stores the aligned reference model by analyzing the similarity between the extracted behavior sequences by using at least one of whether the behavior sequences occurs within a predetermined time and whether information included in the behavior sequences is the same.

5. The system for analyzing the lifestyle of claim 1, wherein the tendency analyzing unit analyzes the user's tendency by comparing data of the lifelogs collected from the users with data which may be obtained based on the reference model storing expert knowledge data and experience data analyzed based on experience of multiple users under the same input condition to extract similarity and difference.

6. The system for analyzing the lifestyle of claim 1, wherein the tendency analyzing unit analyzes an individual tendency by analyzing activity information in an individual social network included in the collected lifelog.

7. A method for analyzing a lifestyle comprising:
collecting lifelogs of multiple users;
storing a reference model generated by analyzing a behavior sequence based on the collected lifelogs;
extracting similar behavior patterns by mining data in the stored reference model by using the lifelogs collected from the users in real time;
analyzing a user's tendency by using the extracted similar behavior patterns; and
generating a personalized lifestyle model based on the analyzed user's tendency.

8. The method for analyzing the lifestyle of claim 7, wherein the lifelogs includes at least one of private data, public data, personal data, anonymous data, connected data, and sensor data.

9. The method for analyzing the lifestyle of claim 7, wherein in the storing of the reference model, the behavior sequences with high similarity are stored as an ontology type reference model in which the behavior sequences with high similarity are connected to each other in a tree form by extracting the behavior sequences in the collected lifelog, analyzing similarity between the extracted behavior sequences, and aligning behavior sequences with high similarity by using a sequence alignment method.

10. The method for analyzing the lifestyle of claim 9, wherein in the storing of the reference model storing unit, the aligned reference model is stored by analyzing the similarity between the extracted behavior sequences by using at least one of whether the behavior sequences occurs within a predetermined time and whether information included in the behavior sequences is the same.

11. The method for analyzing the lifestyle of claim 7, wherein in the analyzing of the tendency, the user's tendency is analyzed by comparing data of the lifelogs collected from the users with data which may be obtained based on the reference model storing expert knowledge data and experience data analyzed based on experience of multiple users under the same input condition to extract similarity and difference.

12. The method for analyzing the lifestyle of claim 7, wherein in the analyzing of the tendency, an individual tendency is analyzed by analyzing activity information in an individual social network included in the collected lifelog.

13. (canceled)
